(19) United States
(12) Patent Application Publication
(10) Pub. No.: US 2018/0319477 A1
(43) Pub. Date: Nov. 8, 2018

(54) AIR VEHICLES

(71) Applicant: Andrew X. Yakub, Stevenson Ranch, CA (US)

(72) Inventor: Andrew X. Yakub, Stevenson Ranch, CA (US)

(21) Appl. No.: 15/972,087

(22) Filed: May 4, 2018

Related U.S. Application Data
(60) Provisional application No. 62/501,661, filed on May 4, 2017.

(51) Int. Cl. B64B 1/58; B64B 1/70; H01M 8/18; B64C 39/00; B64D 27/24

(52) U.S. Cl. CPC B64B 1/58; B64B 1/70; B64D 2027/026; B64C 39/001; B64D 27/24; H01M 8/186

(57) ABSTRACT

The zero carbon emission vehicle as disclosed herein may include a condenser for extracting fluid water from the atmosphere, an electrolyzer for generating hydrogen from the fluid water, and one or more deformable fluid-retaining chambers that couple thereto for selectively adjusting the buoyancy and altitude of the zero carbon emission vehicle in real-time, to maintain the air vehicle in flight substantially without needing to land and refuel the air vehicle. Solar panels provide the energy for the described systems, and the energy from the solar panels can be stored in the form of hydrogen gas which gives buoyancy to the air vehicle.

### BACKGROUND OF THE INVENTION

The present invention generally relates to air vehicles. More specifically, the present invention relates to air vehicles having solar and hydrogen power generators for use in connection with multi-chamber, multi-fluid systems that control the buoyancy and altitude thereof to maintain the air vehicle substantially in flight without the need to land and refuel, thereby substantially reducing or eliminating carbon emissions related with the operation thereof.

A variety of air vehicles such as airplanes, helicopters, hot air balloons, blimps, and zeppelins are known in the art and are used in modern society ever more frequently and for a variety of purposes. Typically, such air vehicles use fossil fuels to generate propulsion and lift. Fossil fuels may combust in an engine to generate energy to provide thrust, to actuate mechanical propellers, or even to generate electricity (e.g., for cabin use). In the case of an airplane, the propulsive forces generated by an engine are used in combination with an airfoil to generate lift. The propulsive force from the engine causes the airplane to move laterally such that air passing under and over the airfoil causes a force opposing gravity to act on the airfoil. The airplane experiences lift when the forces acting on the airfoil overcome the weight of the airplane. The airplane then stays airborne while the engine continues to provide enough thrust such that the negative pressure passing over the airfoil is greater than the weight of the airplane. Although, the airplane can only stay in flight while it has fossil fuels to burn. In this respect, fossil fuels can be particularly disadvantageous because the airplane needs to land and refuel from time-to-time; or otherwise attempt difficult aerial refueling from another airplane which must still land from time-to-time to refuel. Basically either method requires landing at least one plane for refueling purposes. Moreover, refueling costs accumulate with each successive trip and, since fossil fuels are a scarce and non-renewable resource, refueling prices for crude oil and jet fuel may fluctuate depending on current market values. Another drawback is that burning fossil fuels is known to produce byproducts harmful to the environment.

In another example, hot air balloons use heated air to generate lift, e.g., by burning propane or other natural gases. In this respect, the hot air balloon may include one or more burners that generate a flame from a source of compressed propane coupled thereto to generate hot air that rises into and becomes trapped within the balloon. Trapping enough hot air in the balloon will lift the balloon off the ground when the upward force of the trapped rising hot air exceeds the weight of the balloon. Although, of course, over time, air within the balloon cools to atmospheric temperature, thereby decreasing the upward force. After time, hot air within the balloon requires replenishment for the balloon to stay aloft. Once the compressed propane fuel in the tank depletes, it becomes necessary to land the hot air balloon to refuel.

Another way to generate lift (e.g., without burning fossil fuels or natural gases) is through use of a fluid less dense than atmospheric air (e.g., hydrogen, helium gas, etc.). Here, the air vehicle (e.g., a blimp or zeppelin) may include a compartment or chamber for retaining fluid in an amount that generates a buoyant force large enough to overcome the weight of the air vehicle. This allows the air vehicle to rise into the atmosphere until atmospheric air pressure equalizes with the fluid carrying the air vehicle. Although, even these air vehicles typically need to dock to a ground-based station or attach to a service air vehicle from time-to-time as the buoyant fluid in the air vehicle depletes. Accordingly, such air vehicles still need to replenish the necessary fluids and may do so by attaching to a compressed gas tank or other fluid source. Similar to airplanes, air vehicles such as blimps and zeppelins still require land-based infrastructure or some other external/separate refueling system. Also, these air vehicles require an energy source, such as a battery to run systems on board. This battery is usually a solid, or a liquid such as gasoline. Thus, the need for external refilling systems continue to be a significant limiting factor for air vehicles intended to be used in flight for long periods of time.

Drones in particular use batteries to power onboard systems such as propellers (to generate lift), video equipment, sensors, lighting, navigation instruments, etc. The batteries (both liquid and solid batteries) are heavier than air and, as a result, work against maintaining the air vehicle airborne. The energy efficiency of these air vehicles is therefore limited as the air vehicle must expend energy to elevate the very energy source that operates the air vehicle. In some cases, the air vehicle needs additional equipment (e.g., larger or stronger propellers) to generate enough force to lift the air vehicle, which further reduces the efficiency of the drone. Additionally, and similar to the other refueling limitations discussed herein, the operation of onboard systems or even the flight time of the drone is limited by the energy storage capacity of the battery. The battery must be recharged or swapped once depleted, which realistically requires landing and recharging or swapping out the battery for a fresh one. Under either scenario, the drone must land to recharge/refuel.

There exists, therefore, a significant need in the art for a low or zero carbon emission vehicle that includes a solar panel array to power a condenser for extracting fluid water from the atmosphere, an electrolyzer for generating hydrogen from the fluid water, and one or more deformable fluid-retaining chambers that couple thereto for selectively adjusting the buoyancy and altitude of the air vehicle, to maintain the air vehicle in flight substantially without needing to land and refuel the air vehicle. The energy stored in the gaseous hydrogen can be then run through a fuel cell to produce electricity which can be used to propel and navigate the air vehicle, as well as power the onboard systems (e.g., video recording, sensors, refrigeration, etc.). The solar panels may supply all of the energy for the entire system, and may be made out of lightweight, high efficiency solar PV material such as silicon, gallium arsenide, or another thin film semiconductor material (e.g., multi junction cells), having a thickness of 50 microns or less. The solar cells can be put on the top of the gaseous containing chamber such as to maximize sunlight irradiation. The high surface area of such a chamber ensures that the solar cell array can be large enough to cover all energy consumption necessary for the air vehicle including at night and in bad weather or conditions of low solar irradiation.

### SUMMARY OF THE INVENTION

One embodiment of an air vehicle as disclosed herein includes a housing having a first chamber for retaining a buoyant fluid having a density relatively lower than atmospheric air and a second chamber for retaining a fuel, a generator coupled with the housing for supplying renewable electricity to the air vehicle, an electrolyzer operating off electricity supplied by the generator and fluidly coupled with the fuel in the second chamber for producing quantities of the buoyant fluid while the air vehicle is airborne for storage in the first chamber, the first chamber being of a size and shape to retain a sufficient quantity of the buoyant fluid such that the air vehicle may continuously have an overall density relatively lower than atmospheric air to remain airborne therein, and a fuel producer operating off electricity supplied by the generator for producing the fuel from a renewable resource while the air vehicle is airborne.

In one embodiment, the fuel may include a non-carbon based fuel and the air vehicle may thus remain airborne in atmospheric air with zero carbon emissions. Here, the fuel producer may include a precipitation condenser, the fuel may include water, and the second chamber may be a water storage tank. Moreover, the buoyant fluid may be hydrogen and the first chamber may thus be a hydrogen tank. The air vehicle may also include a third chamber that includes an oxygen storage tank that selectively receives and retains a quantity of oxygen. In this embodiment, the first chamber, the second chamber, and the third chamber may be made from a deformable material that allows each of the chambers to vary in volumetric size and shape depending on the relative quantity of the buoyant fluid, the fuel, and/or the oxygen within the housing. In one embodiment, each of the first chamber, the second chamber, and the third chamber may be generally oriented vertically relative to one another, with the first chamber being positioned at a bottom of the air vehicle, the third chamber being positioned above and adjacent the first chamber, and the second chamber being positioned above and adjacent the third chamber within the housing.

Additionally, the air vehicle may include a fuel cell fluidly coupled with the buoyant fluid in the first chamber and the oxygen in the third chamber for generating electricity and water therefrom. Additionally or alternatively, the air vehicle may also include a water recycling system fluidly coupling the fuel cell to the fuel producer or the second chamber. A first pump may be designed to move pressurized fuel from the second chamber to the electrolyzer and a second pump may be designed to move pressurized oxygen from the electrolyzer to the oxygen storage chamber. The first pump and/or the second pump may also act as one-way check valves to prevent backflow of the pressurized fuel or the pressurized oxygen.

In another aspect of the embodiments disclosed herein, the generator may include a solar panel coupled to an exterior surface of the housing and may include a relatively lightweight solar PV material having a thickness of less than 50 microns. The solar panel may be designed to selectively move relative to the housing for reorientation relative to a sun, to maximize sun exposure as the sun travels through the sky during the day. Here, a controller may simultaneously operate the generator, the electrolyzer, and the fuel producer in real-time to self-regulate an airborne height of the air vehicle. A battery storage system may electrically couple with the generator (e.g., a fuel cell or solar panel) for receiving and storing electricity.

Other features of the air vehicle may include a housing made from a rigid or flexible material, at least one vent for releasing at least one of the buoyant fluid from the first chamber or the fuel from the second chamber, a center of gravity below a mid-height of the air vehicle, and a system for gravity feeding the fuel from the fuel producer to the second chamber. The air vehicle may also include a first check valve positioned between the second chamber and the electrolyzer to prevent backflow of fuel to the second chamber, and a second check valve positioned between the fuel producer and the second chamber to prevent backflow of the fuel to the fuel producer.

In another aspect, a process for operating an air vehicle airborne may including steps for storing a quantity of a buoyant fluid having a density relatively lower than atmospheric air in a first chamber of a housing of the air vehicle, retaining a quantity of a fuel in a second chamber of the housing of the air vehicle, producing the buoyant fluid for storage in the first chamber from the fuel in the second chamber while the air vehicle is airborne, the first chamber being of a size and shape to retain a sufficient quantity of the buoyant fluid such that the air vehicle continuously has an overall density relatively lower than atmospheric air to remain airborne, and resupplying the fuel to the second chamber from a renewable resource while the air vehicle remains airborne. More specifically, the producing step may include the step of producing hydrogen and oxygen with an electrolyzer and the resupplying step may include the step of precipitating water from atmosphere with a condenser.

In another aspect, the process may further include pumping the hydrogen from the electrolyzer to the first chamber as the buoyant fluid and storing the oxygen produced by the electrolyzer in an oxygen chamber. Additionally, the system may generate electricity and water with a fuel cell from the hydrogen in the first chamber and the oxygen in the oxygen chamber and then pump the water from the fuel cell to the second chamber. Similarly, the air vehicle may pump precipitated water from the condenser to the second chamber.

Additionally, the altitude of the air vehicle may be controlled by regulating the quantity of buoyant fluid within the first chamber or regulating the quantity of fuel in the second chamber. This may include expanding the first chamber and increasing the pressure therein by increasing the quantity of buoyant fluid therein, thereby reducing the overall density of the air vehicle, or expanding the second chamber and increasing the pressure therein by increasing the quantity of the fuel therein, thereby increasing the overall density of the air vehicle. Conversely, the air vehicle may expel at least one of the buoyant fluid or the fuel from the air vehicle to atmosphere while airborne, to decrease the pressure in the relative first chamber or second chamber.

In another aspect, a controller may regulate operation of a solar panel, a condenser, an electrolyzer, or a fuel cell in real-time. This may include increasing the quantity of the fuel in the second chamber by activating the condenser and decreasing the quantity of the fuel in the second chamber by activating the electrolyzer; or increasing the quantity of buoyant fluid in the first chamber by activating the electrolyzer and decreasing the quantity of buoyant fluid in the first chamber by activating the fuel cell. The air vehicle may also generate electricity from the solar panel.

One embodiment of an air vehicle as disclosed herein may include a condenser for extracting fluid water from the atmosphere, an electrolyzer for generating hydrogen from the fluid water, and one or more deformable fluid-retaining chambers (e.g., each housing a different fluid) to control the lift of the air vehicle by controlling the vehicle buoyancy in the atmosphere. The fluids used in connection with the air vehicle may have different densities (e.g., hydrogen generated by the electrolyzer; and water accumulated by the condenser) and the amount of each fluid relative to the other may be managed in real-time by a controller to set the buoyant force acting on the vehicle (e.g., to control the altitude or height of the air vehicle in the atmosphere). In other words, the air vehicle may be able to self-regulate its altitude through controlled manipulation of the quantity of fluids therein at any given point in time.

Additionally, the air vehicle disclosed herein may generate power through use of a solar power system, such as to power onboard components and operational controllers. For example, the electricity generated by the solar power system may be used to operate the electrolyzer, for producing hydrogen and oxygen from water by electrolysis, or a fuel cell. In particular, the fuel cell may use hydrogen stored in one of the vehicle chambers to generate electricity or thrust. The electricity produced by the solar power system may be stored in the form of hydrogen gas in the buoyancy chamber or may be used to operate the air vehicle, such as the onboard electrical devices (e.g., controller, heating, air conditioning, lighting, navigation instruments, valves, pumps, etc.). Alternatively, if no additional buoyancy is needed, then the electricity from the solar cells can be stored in conventional solid/liquid batteries.

Although, an electricity storage system such as a battery may not be necessary as the electrical energy generated by the solar power system may be stored in the hydrogen produced by electrolysis. The fuel cell may convert the energy stored in the hydrogen gas back to electrical energy as needed. Using hydrogen gas as an energy storage system may be more energy efficient than using a solid or liquid energy storage system (such as a battery) since hydrogen is lighter than air. Thus, the air vehicle as disclosed herein may not need to expend additional energy just to keep the energy storage system airborne. In other words, the energy storage system as disclosed herein facilitates buoyancy and lift instead of opposing it as does a liquid or solid battery. In turn, facilitating buoyancy and lift may require fewer and smaller mechanical components to maintain the air vehicle airborne, which further increases overall system efficiency. Furthermore, excluding a battery from the system may obviate the need to land and recharge or land and swap the battery.

Additionally, the air vehicle may generate its own water supply onboard by way of collecting moisture from the atmosphere with a condenser, and then converting the moisture in a water retaining chamber. To this end, the condenser may also be powered by the solar power system and/or the fuel cell. In one embodiment, the air vehicle may include three fluid storage chambers, including one for hydrogen, one for water, and one for atmospheric air. The vehicle may also have a chamber to house pure oxygen produced by the electrolyzer.

The chambers may be flexible to allow for variable chamber shapes, sizes, and volumes. For example, if the fluid supply of one chamber depletes, thereby shrinking in size, the chamber size of another (e.g., adjoining) fluid chamber may expand without changing the overall shape and/or size of the air vehicle. Additionally, flexibility may also permit retaining larger quantities of fluid, i.e., chambers may expand in size to accommodate more fluid. More generally, variable chamber shapes and volumes allow for variable overall vehicle shape and volume, which in turn allows the vehicle to fit in airspaces that may vary in size.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1A is a schematic environmental view illustrating an air vehicle as disclosed herein on the ground;

FIG. 1B is a schematic environmental view similar to FIG. 1A, illustrating the air vehicle ascending to a first elevated position;

FIG. 1C is a schematic environmental view similar to FIGS. 1A and 1B, illustrating the air vehicle descending to a second elevated position off the ground and relatively lower than the first elevated position illustrated with respect to FIG. 1B;

FIG. 2 is a schematic view illustrating an internal side view of the air vehicle of FIGS. 1A-1C, further illustrating a precipitation condenser for producing water storable by the air vehicle in a water chamber and usable by an electrolyzer;

FIG. 3 is a schematic view of the internal side view of the air vehicle similar to FIG. 2, further illustrating the electrolyzer producing hydrogen gas and oxygen gas from water in the water chamber, for storage in a respective hydrogen chamber and an oxygen chamber;

FIG. 4 is a schematic view of the internal side view of the air vehicle similar to FIGS. 2 and 3, further illustrating a fuel cell generating electrical energy from a supply of the hydrogen gas and the oxygen gas;

FIG. 5 is a schematic view of the internal side view of the air vehicle similar to FIGS. 2-4, further illustrating operation of the fuel cell for generating electrical energy from a supply of hydrogen gas and air;

FIG. 6A is a schematic view illustrating the internal side view of the air vehicle of FIGS. 1A-1C, including a hydrogen chamber, an atmospheric air chamber, an oxygen chamber, and a water chamber filled to a first capacity;

FIG. 6B is a schematic view of the internal side view of the air vehicle similar to FIG. 6A, further illustrating each of the hydrogen chamber, the atmospheric air chamber, the oxygen chamber, and the water chamber filling to a second capacity relatively larger than those shown with respect to FIG. 6A;

FIG. 7A is a schematic view of the air vehicle on the ground;

FIG. 7B is a schematic view similar to FIG. 7A, further illustrating the air vehicle at a raised elevation or altitude in response to a decrease in the amount of water in the water chamber and an increase in the amount of hydrogen in the hydrogen chamber and the amount of oxygen in the oxygen chamber, relative to FIG. 7A;

FIG. 8 is an enlarged schematic view of the internal side view of the air vehicle taken about the circle 8 in FIG. 4, further illustrating a precipitation condenser condensing water vapor from the environment and converting it to liquid water; and

FIG. 9 is a schematic top view of the air vehicle, further illustrating a solar power system, including a set of solar cells contained within a plurality of solar panels, for converting sunlight into electrical energy.

### DETAILED DESCRIPTION OF THE DRAWINGS

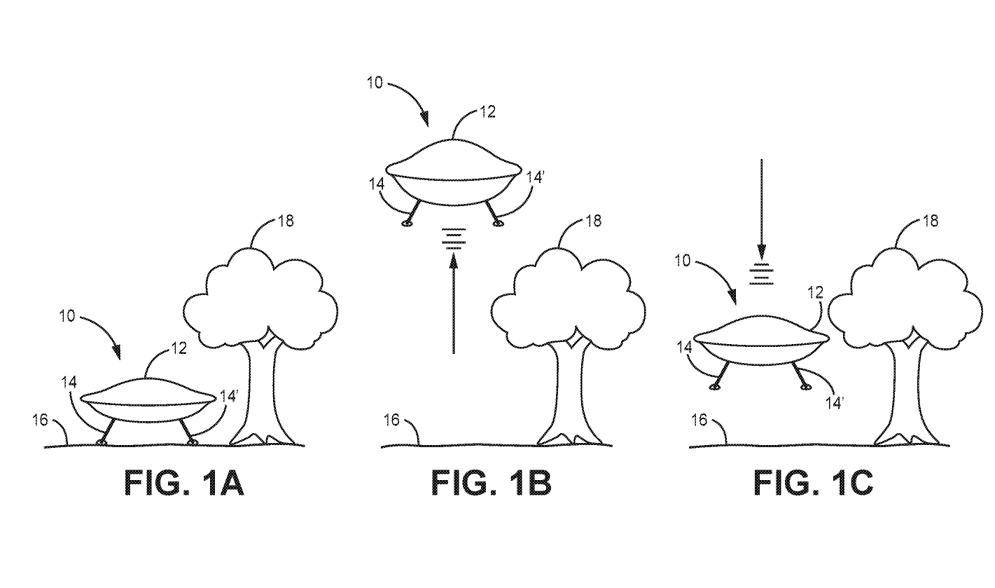

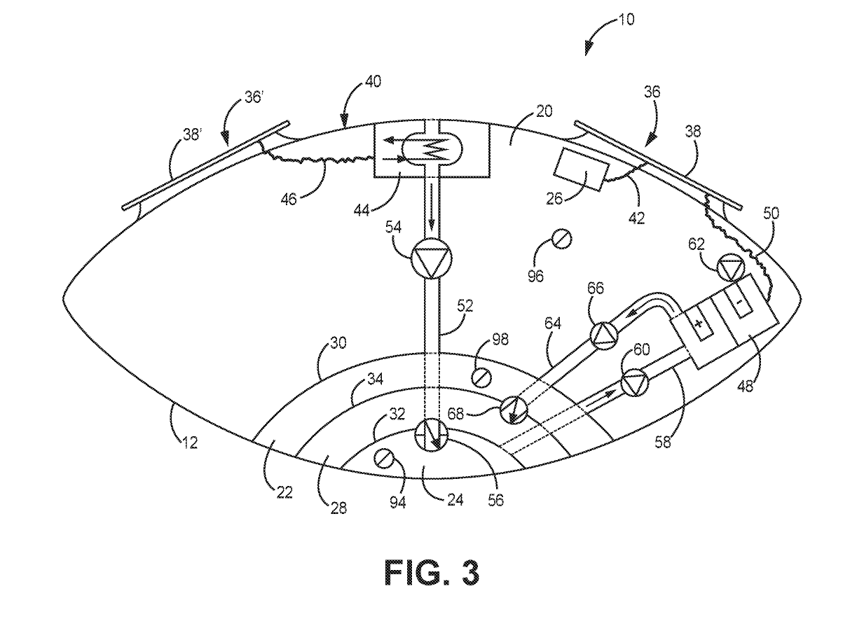

As shown in the exemplary drawings for purposes of illustration, embodiments for an air vehicle as disclosed herein are generally referred to in FIGS. 1A-9 by reference numeral 10. In general, the air vehicle 10 as disclosed herein is designed to substantially reduce and/or completely eliminate carbon emissions during operation. This may be particularly desirable over known prior art air vehicles to substantially eliminate harmful pollutants produced as by-products of burning fossil fuels. More specifically as illustrated in FIGS. 1A-1C, the air vehicle 10 may include a housing 12 having a set of retractable and/or non-retractable landing gear 14, 14′ coupled thereto as may be known and used in the art in connection with air vehicles. As shown in FIG. 1A, the landing gear 14, 14′ of the air vehicle 10 are deployed and initially on a ground level 16. With the generation of the lift, as described in more detail herein, the air vehicle 10 may increase in atmospheric height or altitude as shown, e.g., in FIG. 1B relative to FIG. 1A (the relative positioning of which is shown with respect to a common reference point by a tree 18). Additionally, the air vehicle 10 may regulate its atmospheric altitude such that it may descend from the position illustrated with respect to FIG. 1B to the position shown in FIG. 1C. To this end, the air vehicle 10 may operate with the landing gear 14, 14′ deployed as shown in FIGS. 1A-1C, or the air vehicle 10 may operate with the landing gear 14, 14′ retracted (e.g., as shown with respect to FIGS. 3-5). Additionally, once airborne as shown in FIGS. 1B and 1C, the air vehicle 10 may continue to regulate its altitude, as described in more detail herein, and may do so for durations relatively longer than those air vehicles known in the art.

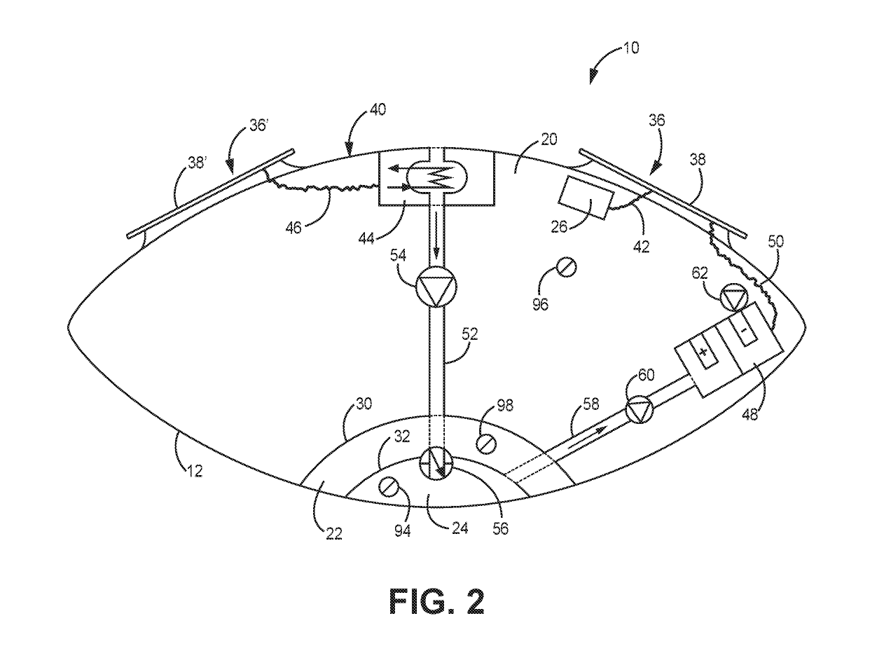

More specifically, FIG. 2 illustrates the air vehicle 10 having multiple chambers, including a hydrogen chamber 20 for storing hydrogen gas, an air chamber 22 for storing air, and a water chamber 24 for storing water. Since hydrogen gas is generally relatively lighter than atmospheric air, the air vehicle 10 may experience atmospheric lift when the quantity of hydrogen gas in the hydrogen chamber 20 is sufficient to render the overall density of the air vehicle 10 less dense than atmospheric air at the then current altitude of the vehicle 10. To this end, increasing the amount of hydrogen stored by the vehicle 10 increases its buoyancy and lift, which will tend to ascend the altitude of the vehicle 10 in the atmosphere until the pressure within the vehicle 10 equalizes with the atmospheric air pressure, which decreases with increased altitude.

The air chamber 22 may store air (e.g., atmospheric air at various temperatures and/or densities) to aid in the control of the altitude of the air vehicle 10 by counter balancing the relatively lighter hydrogen gas stored in the hydrogen chamber 20. Increasing the amount of atmospheric air in the vehicle 10 relative to the amount of hydrogen gas in the vehicle 10 may tend to decrease the altitude of the vehicle 10. The water chamber 24 may store water for production of hydrogen and may further aid in controlling the altitude of the air vehicle 10 by counter balancing the upward force generated by the hydrogen gas stored in the hydrogen chamber 20, namely because water is relatively heavier than hydrogen gas and atmospheric air. The air vehicle 10 may further include a control system 26 that controls the relative quantity of hydrogen in the hydrogen chamber 20, air in the air chamber 22, and/or water in the water chamber 24 in real-time, among controlling other operational components as described herein, to control the atmospheric altitude of the vehicle 10.

In an alternative embodiment illustrated in FIG. 3, the air vehicle 10 may include an oxygen chamber 28 for storing oxygen gas produced as a byproduct of electrolysis. The oxygen storage chamber 28 may further aid in controlling the altitude of the air vehicle 10 by counter balancing the lift generated by the hydrogen gas stored in the hydrogen chamber 20, similar to the air chamber 22 and the water chamber 24, as oxygen gas is relatively heavier than hydrogen and atmospheric air.

The chambers 20, 22, 24, 28 may be oriented vertically with respect to one another so that chambers storing denser substances are positioned below the respective chambers storing lighter substances. Specifically, as illustrated in FIG. 2, the hydrogen chamber 20 housing the lightest hydrogen gas may be positioned above the air chamber 22, and the air chamber 22 may be positioned above the water chamber 24. In the alternative embodiment illustrated in FIG. 3, the air chamber 22 may be sandwiched below the hydrogen chamber 20 on one side and above the oxygen chamber 28 on the other. Here, the oxygen chamber 28 may be positioned above the water chamber 24, as oxygen gas is generally relatively denser than atmospheric air and generally less dense than water. The vertical arrangement of the chambers 20, 22, 24, 28 according to density may provide enhanced stability by lowering the center of gravity, such as to help prevent the vehicle 10 from flipping upside down mid-flight.

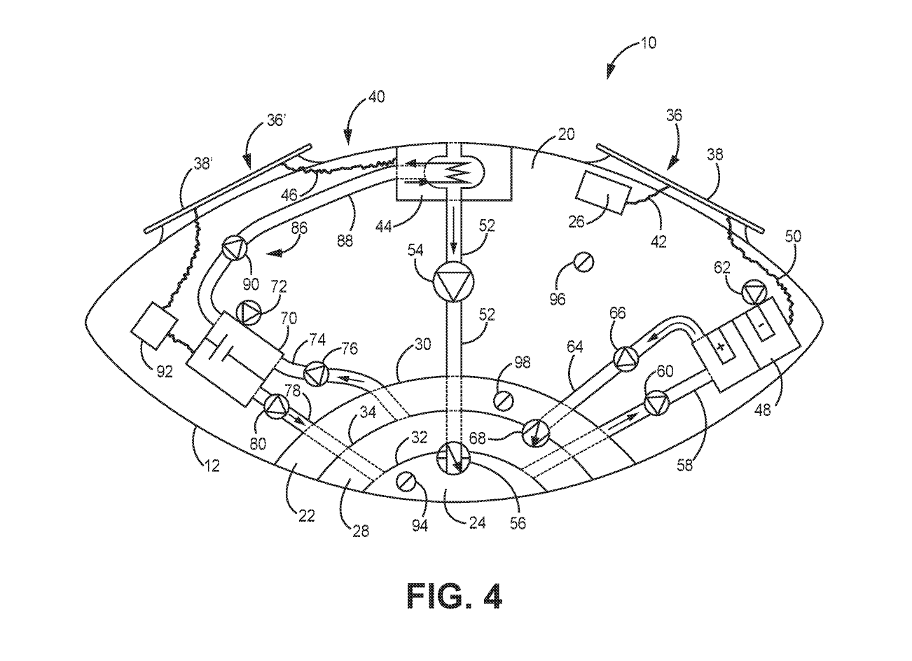

Each of the chambers 20, 22, 24, 28 may generally be separated within the air vehicle 10 by a series of membranes that fasten/attached to or otherwise for part of the interior of the housing 12. More specifically as shown in FIGS. 3-4, the hydrogen chamber 20 may be defined generally by a portion of the housing 12 and a membrane 30 coupled thereto and positioned generally within the interior of the housing 12. The membrane 30 may be made from a material that permits expansion and/or contraction depending on the quantity of hydrogen within the hydrogen chamber 20. In the embodiment shown with respect to FIG. 2, the membrane 30 generally cooperates with a portion of the housing 12 and an internally located membrane 32 to generally define the air chamber 22. Similarly, the membrane 32 may also be made from a flexible material that permits expansion and/or contraction depending on the quantity of air in the air chamber 22 and/or the quantity of water within the water chamber 24. The water chamber 24, of course, is then defined generally by the housing 12 and the internally positioned membrane 32. The size and/or shape of the water chamber 24 may expand and/or contract based on the relative size of the flexible housing 12 and/or flexible membrane 32.

In the alternative embodiment illustrated with respect to FIG. 3, the membrane 30 is illustrated separating the hydrogen chamber 20 from the air chamber 22. Although, in this embodiment, the oxygen chamber 28 is interposed between the air chamber 22 and the water chamber 24. Here, a third membrane 34 separates the air chamber 22 from the oxygen chamber 28. Similar to the above, the third membrane 34 may be made from a flexible material and cooperate with the housing 12 to generally define the size and/or shape of the oxygen chamber 28 along with the second membrane 32. Of course, the relative size of the membrane 34 may react to relative quantities of air within the air chamber 22 and/or the quantity of oxygen within the oxygen chamber 28.

In general, the housing 12 and/or any of the membranes 30, 32, 34 may be made of a flexible material such that changes in internal and/or external pressure on the boundaries of any of the housing 12 and/or the chambers 20, 22, 24, 28 allow for expansion and/or contraction to reach pressure equilibrium therein. Changes in equilibrium, e.g., may result from changes in atmospheric air pressure on an exterior of the housing 12 or the relative quantity of fluid within each of the chambers 20, 22, 24, 28; such as, e.g., increasing and/or decreasing the quantity of air within the air chamber 22, increasing and/or decreasing the quantity of water within the water chamber 24, and/or increasing and/or decreasing the quantity of oxygen within the oxygen chamber 28. In one embodiment, the thickness of the material forming the housing 12 and/or the membranes 30, 32, 34 may vary depending on the desired relative overall size of each of the housing 12 and/or the chambers 20, 22, 24, 28.

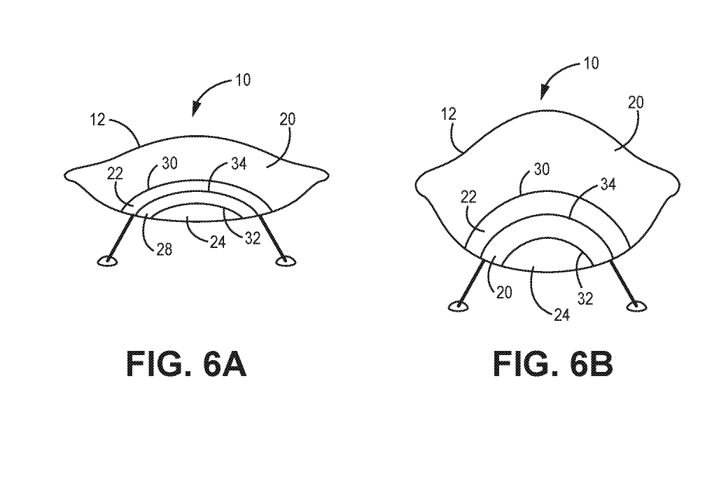

FIGS. 6A and 6B illustrate the relative flexible nature of the housing 12 and the membranes 30, 32, 34 by way of changing the size of the chambers 20, 22, 24, 28. In FIG. 6A, for example, the chambers 20, 22, 24, 28 are in a first relatively contracted state. Here, the overall outer periphery of the outer housing 12 is relatively smaller in FIG. 6A than in FIG. 6B where in the outer housing 12 is illustrated in a relatively expanded state. This may result from generally expanding the quantity of fluid in any one of the chambers 20, 22, 24, 28. Additionally, each of the membranes 30, 32, 34 in FIG. 6A are initially shown in a relatively contracted state since each of the chambers 20, 22, 24, 28 retain a relatively lower amount of fluid than shown with respect to FIG. 6B. To this end, FIG. 6B illustrates that the outer housing 12 and each of the membranes 30, 32, 34 have been stretched out (i.e., relatively larger than in FIG. 6A) to permit retaining an increased amount of fluid within each of the respective chambers 20, 22, 24, 28. Of course, as described herein, the relative quantity of fluid in each of the chambers 20, 22, 24, 28 may regulate the altitude of the air vehicle 10 in the atmosphere, such as in real-time. Each of the chambers 20, 22, 24, 28 may also expand and/or contract relative to one another, depending on the desired altitude of the air vehicle 10. For example, to increase the altitude of the air vehicle 10, the quantity of hydrogen gas within the hydrogen chamber 20 may increase, thereby increasing the size of the hydrogen chamber 20, while the quantity of water with in the water chamber 24 may decrease, thereby decreasing the size of the water chamber 24, and vice versa. The controller 26, e.g., may regulate in real-time the quantity of fluids within the chambers 20, 22, 24, 28, depending on the desired altitude of the air vehicle 10. In this respect, e.g., altering the quantity of water within the water chamber 24 may have a larger impact on the altitude of the air vehicle 10 than altering the same volume of oxygen within the oxygen chamber 28 as a result of the relative density of water relative to hydrogen gas.

To power the air vehicle 10, one or more solar power systems 36 having one or more solar cells 38 that may attach to a top, upward-facing surface 40 of the housing 12 as shown, e.g., in FIGS. 2-5 and 9. The solar power systems 36 may supply all the energy for the air vehicle 10 and the solar cells 38 may be made of a lightweight, high efficiency solar PV material such as silicon, gallium arsenide, or another thin film semiconductor material (e.g., multi junction cells) having a thickness of 50 microns or less. The solar cells 38 may be positioned on top of the housing 12 (i.e., the outermost gaseous containing chamber) to maximize sunlight irradiation. The high surface area of the housing 12 ensures that the array of the solar cells 38 is large enough to generate enough energy necessary to maintain the air vehicle 10 in flight, including at night and in bad weather or conditions of low solar irradiation. In another aspect of this embodiment, the one or more solar power systems 36 may be positioned to maximize light absorption from the sun at any given point in the day. To this end, the one or more solar power systems 36 may be statically attached to the housing 12, wherein the air vehicle 10 is able to re-orient itself during the day so the solar power systems 36 continue to face the sun to maximize light absorption. Alternatively, the one or more solar power systems 36 may move and/or reposition themselves along the exterior of the housing 12, again to maximize light absorption as the sun moves through the sky during the day.

More specifically with respect to FIGS. 2-5, the solar power system 36 is illustrated coupled with the control system 26 by way of a communication coupling 42 and the solar power system 36′ is shown coupled to a precipitation condenser 44 by a power coupling 46. In one embodiment, each of the solar panel systems 36, 36′ may be coupled together (e.g., daisy-chained) such that the coupling of the solar power system 36 to the controller 26 by the communication coupling 42 allows the control system 26 to communicate with both of the solar power systems 36, 36′ shown in FIGS. 2-5. The communication coupling 42 may be by hard wire or wireless communication, wherein, in embodiments wherein the communication coupling 42 is wireless, the control system 26 does not necessarily need to be physically coupled to all of the solar power systems 36 to communicate and/or operate the solar power systems 36. In a similar manner, the control system 26 may communicate and/or operate the precipitation condenser 44 by way of the power coupling 46. Additionally, FIGS. 2-5 illustrate that the solar power system 36 may couple to an electrolyzer 48 by a similar power coupling 50. Each of the couplings 42, 46, 48 may selectively power and/or engage in unilateral and/or bilateral communication between the solar power system(s) 36 and any of the control system 26, the precipitation condenser 44, and/or the electrolyzer 48.

The solar power system 36 may power the precipitation condenser 44 to collect moisture from the atmosphere and convert the moisture to liquid water in a manner described herein. The liquid water generated by the precipitation condenser 44 may then be pumped into the water chamber 24 through a conduit 52 leading from the precipitation condenser 44 and possibly through the hydrogen chamber 20, the air chamber 22 (FIG. 2), and/or the oxygen chamber 28 (FIG. 3) to the water chamber 24. A water pump 54 may be located along the conduit 52 that may be activated by the control system 26 to pump water from the precipitation condenser 44 into the water chamber 24 as needed and/or desired. For example, continued operation of the precipitation condenser 44 will generate more water for storage within the water chamber 24. This may be desired in the event additional weight may be needed to lower the altitude of the air vehicle 10. Alternatively, additional water may be needed to operate the electrolyzer 48, as described in more detail below.

Moreover, a one-way check valve 56 may be embedded in the membrane 32 that allows water to flow from the conduit 52 into the water chamber 24 in one direction only. When the water pump 54 is not activated, the check valve 56 may prevent water from flowing back out of the water chamber 24 toward the precipitation condenser 44, as may be the tendency since the internal pressure of the water chamber 24 may be greater than that of the conduit 52 or the precipitation condenser 44. In an alternative embodiment, the water pump 54 may act as the one-way check valve when in an “off” or non-operation position.

The electrolyzer 48 uses water as part of an electrolysis process for generating hydrogen gas and oxygen gas. In this respect, water may be pumped from the water chamber 24 to the electrolyzer 48 through a conduit 58 leading from the water chamber 24 through the air chamber 22 (FIG. 2) and the oxygen chamber 24 (FIG. 3). As shown, the electrolyzer 48 is housed generally within the hydrogen chamber 20, although the electrolyzer 48 may be housed elsewhere in the air vehicle 10, such as in its own housing or compartment generally coupled to the housing 12. A water pump 60 located along the conduit 58 may be activated by the control system 26 to pump water from the water chamber 24 into the electrolyzer 48 to refill the electrolyzer 48 as may be needed and/or desired. For example, during operation, the electrolyzer 48 generates hydrogen and oxygen gas and generally depletes the quantity of water therein. Here, the water pump 60 may be activated to pump water from the water chamber 24 to the electrolyzer 48 to replenish the quantity of water therein and to ensure continued production of hydrogen and oxygen gas as part of the electrolysis process.

Hydrogen gas generated by the electrolyzer 48 as part of the electrolysis process may then be pumped into the hydrogen chamber 20 by a hydrogen pump 62 to help maintain the air vehicle 10 afloat. The hydrogen chamber 20 may have a capacity to store a quantity of hydrogen gas sufficient to maintain desired atmospheric buoyancy or altitude of the vehicle 10 while the electrolyzer 48 replenishes hydrogen through the electrolysis process. Thus, the air vehicle 10 may be self-sufficient and thereby capable of staying afloat for substantial durations, or until maintenance is required, by consistently generating water with the precipitation condenser 44 (for storage in the water chamber 24) and that may be used to produce hydrogen gas and oxygen gas by way of the electrolyzer 48. In the embodiment shown with respect to FIG. 2, oxygen gas produced by the electrolyzer 48 may be expelled to the external environment and otherwise not saved or stored within the housing 12.

In an alternative embodiment wherein the housing 12 includes the oxygen chamber 28, as illustrated in FIG. 3, the air vehicle 10 may store oxygen produced by the electrolyzer 48 in the oxygen chamber 28. Here, an oxygen conduit 64 may lead from the electrolyzer 48 through the hydrogen chamber 20 and the air chamber 22 to the oxygen chamber 28 so oxygen may be pumped from the electrolyzer 48 to the oxygen chamber 28, such as by way of an oxygen pump 66 located along the conduit 64. A one-way check valve 68 may embed within the membrane 34 to facilitate one-way flow of oxygen from the conduit 64 into the oxygen chamber 28. When the oxygen pump 66 is not activated, the check valve 68 may prevent backflow of oxygen out of the oxygen chamber 28 toward the electrolyzer 48, as may be the tendency since the internal pressure of the oxygen chamber 28 may be greater than that of the conduit 64 and/or the electrolyzer 48. In an alternative embodiment, the oxygen pump 66 may act as a one-way check valve to prevent backflow of oxygen from the oxygen chamber 28 to the electrolyzer 48 when in an “off” non-operational position.

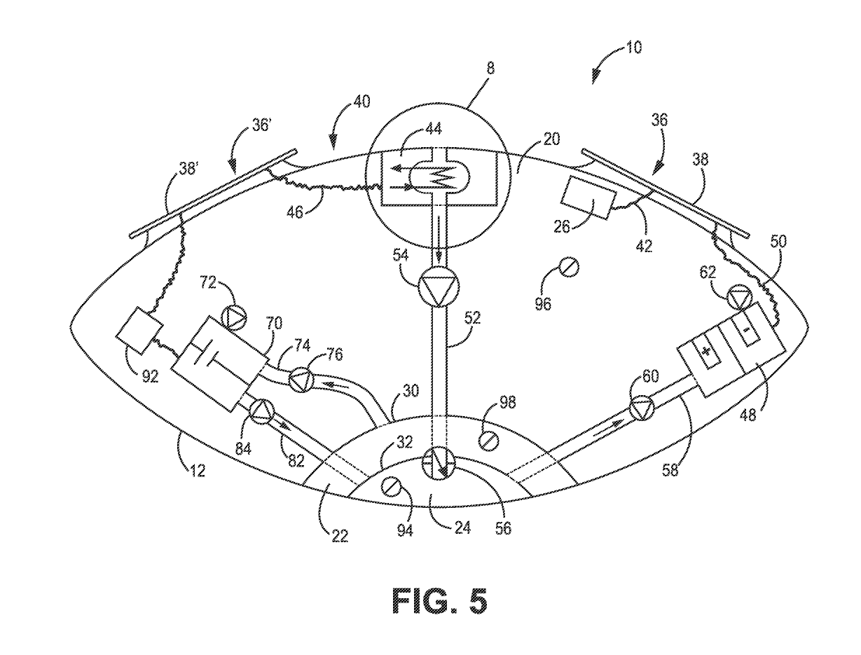

In another alternative embodiment as shown in FIG. 4, the air vehicle 10 may include a fuel cell 70. In FIGS. 4-5, the fuel cell 70 is illustrated housed within the hydrogen chamber 20, although the fuel cell 70 may be located elsewhere with respect to the housing 12, such as in its own compartment or housing coupled thereto. To operate, as illustrated in FIG. 4, the fuel cell 70 may intake hydrogen gas from the hydrogen chamber 20 and oxygen gas from the oxygen chamber 28 to produce electricity and water vapor. The electricity produced by the fuel cell 70 may be used to propel and navigate the air vehicle 10, including powering external propellers, onboard systems (e.g., the control system 26, video recording equipment, sensors, refrigeration, etc.), and/or other systems and controls such as the precipitation condenser 44, the water pump 54, the water pump 60, the electrolyzer 48, and/or the oxygen pump 66. In this respect, the fuel cell 70 may operate in conjunction with or in place of the solar power system 36. A hydrogen pump 72 may pump hydrogen gas from the hydrogen chamber 20 into the fuel cell 70. Furthermore, the fuel cell 70 may receive oxygen from the oxygen chamber 28 by way of a conduit 74 coupled thereto and generally extending through the hydrogen chamber 20 and the air chamber 22. An oxygen pump 76 located along the conduit 74 may help move oxygen from the oxygen chamber 28 to the fuel cell 70. Water vapor produced as a byproduct of the process of the fuel cell 70 may be expelled to the external environment or otherwise pumped back into the water chamber 24 by a recirculation system (e.g., a conduit 78 and a pump 80 as shown in FIG. 4) for storage therein.

In an alternative embodiment, as illustrated in FIG. 5, the fuel cell 70 may use air from the air chamber 22 in addition to or instead of oxygen. In this embodiment, a conduit 82 may lead from the air chamber 22 through the hydrogen chamber 20 to the fuel cell 70 though which air may be pumped therefrom. An air pump 84 may be located along the conduit 82 to help move or pump air from the air chamber 28 to the fuel cell 70. Alternatively, the fuel cell 70 may use atmospheric air external to the vehicle 10 instead of or in addition to air stored in the air chamber 22 and/or oxygen stored in the oxygen chamber 28.

In an alternative embodiment, as illustrated by FIG. 4, the air vehicle 10 may include a water recycling system 86 to send water vapor produced by the fuel cell 70 to the precipitation condenser 44 and/or ultimately to the water chamber 24. Here, a conduit 88 may lead from the fuel cell 70 through the hydrogen chamber 20 to the precipitation condenser 44 through which water vapor may be transferred. A water vapor pump 90 located along or otherwise inline with the conduit 88 may pump the water vapor byproduct from the fuel cell 70 to the precipitation condenser 44. The precipitation condenser 44 may then convert the water vapor into liquid water to be transferred to the water chamber 24, as described herein.

In an alternative embodiment, as illustrated in FIGS. 4 and 5, electrical energy generated by the solar power system 36 and/or by the fuel cell 70 may be stored in an electricity storage system 92, such as a battery. The electricity storage system 92 is illustrated as housed within the hydrogen chamber 20, although the electricity storage system 92 may be housed elsewhere in the air vehicle 10, such as in its own housing or compartment generally coupled to the housing 12. The electricity storage system 92 may include batteries and capacitors useful for storing electrical energy which may power external propellers, onboard systems, and/or other components for operating the vehicle 10, including, e.g., the precipitation condenser 44 and/or the electrolyzer 48.

In alternative embodiments, water from the ground may be pumped into the water chamber 24 and saved for later production of hydrogen and/or oxygen by the electrolyzer 48. The water chamber 24 may be configured to couple to an external water source such as by way of an embedded inlet valve 94 in the housing 12. In another aspect of these embodiments, the hydrogen chamber 20 may be configured to receive and store hydrogen from a ground-based station. In this respect, the hydrogen chamber 20 may be configured to couple to an external hydrogen source by way of an embedded inlet valve 96. In another alternative aspect of these embodiments, atmospheric air may be pumped into the air chamber 22 to control the quantity of air in the air chamber 22 and thereby the atmospheric buoyancy of the vehicle 10. The air chamber 22 may be configured to couple to with an external air pump such as by way of an embedded inlet valve 98.

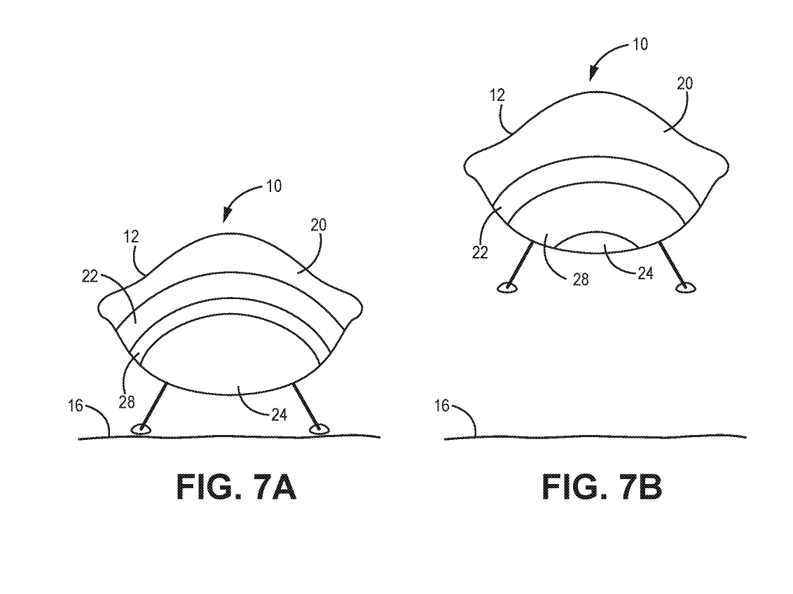

FIGS. 7A and 7B illustrate an example of how each of the chambers 20, 22, 24, 28 may appear when the air vehicle 10 is on the ground 16 (FIG. 7A) or airborne (FIG. 7B). FIG. 7A illustrates the water chamber 24 being of a relatively greater size than the hydrogen chamber 20 and the oxygen chamber 28. This indicates that the air vehicle 10 includes more water (the heaviest of the liquids storable by the air vehicle 10) than either hydrogen gas or oxygen gas. Here, the overall density of the vehicle 10 may be greater than that of atmospheric air such that the air vehicle 10 is on the ground level 16. Increasing the quantity of hydrogen gas in the hydrogen chamber 20 and/or the quantity of oxygen gas in the oxygen chamber 28, in addition to decreasing the quantity of water within the water chamber 24, may result in the air vehicle 10 decreasing in overall density such that the lighter liquids therein cause the air vehicle 10 to raise off the ground as shown in FIG. 7B. The ability of the chambers 20, 22, 24, 28 to increase and/or decrease in size based on the relative quantities of respective liquids therein enables the vehicle 10 to control its altitude in the atmosphere.

Since the density of air in the atmosphere decreases with increased altitude, the vehicle 10 may control its altitude in the atmosphere by adjusting its overall density. For example, the control system 26 may calibrate or synchronize increases and/or decreases in the amount of respective fluids within the chambers 20, 22, 24, 28. The fact that each of the chambers 20, 22, 24, 28 may expand and/or contract provide additional flexibility for the air vehicle 10 to adjust its density based on the desired altitude relative to the atmospheric air pressure. Specifically, in one example, if the air vehicle 10 were to decrease the quantity of water, thereby contracting or decreasing the size of the water chamber 24, and increase the quantity of hydrogen gas and/or oxygen gas, thereby expanding or increasing the size of the hydrogen chamber 20 and/or the oxygen chamber 28, the density of the air vehicle 10 may decrease and cause the vehicle 10 to ascend within the atmosphere until it reaches an altitude at which the density of air in the atmosphere is equivalent to the overall density of the vehicle 10, and vice versa. This is essentially how the air vehicle 10 may regulate its altitude at any given point in time.

Of course, the quantity of water within the water chamber 24 may be increased through activation and use of the precipitation condenser 44, and may be decreased through activation and use of the electrolyzer 48. Additionally, the quantity of hydrogen within the hydrogen chamber 20 may be increased by activation and use of the electrolyzer 48 and decreased through activation and use of the fuel-cell 70. Moreover, the quantity of oxygen within the oxygen chamber 28 may be increased by activation and use of the electrolyzer 48 and may be decreased through activation and use of the fuel-cell 70. The control system 26 may regulate in real-time the operation of the precipitation condenser 44, the electrolyzer 48, and/or the fuel-cell 70 to maintain the quantity of hydrogen in the hydrogen chamber 20, the quantity of water in the water chamber 24, and/or the quantity of oxygen in the oxygen chamber 28 at desired quantities at any given point in time.

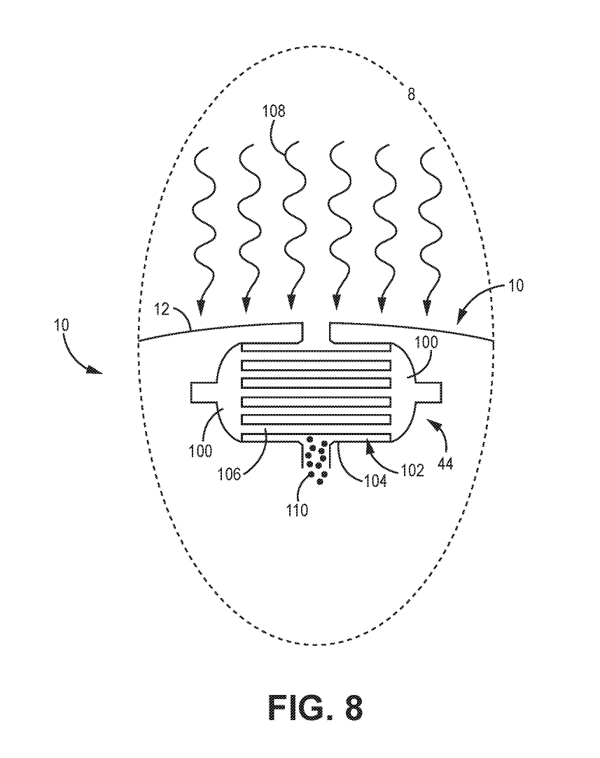

Additionally, FIG. 8 illustrates the general operation of the precipitation condenser 44 for converting water vapor from the atmosphere into liquid water for storage within the water chamber 24 of the air vehicle 10. The precipitation condenser 44 may include a set of reservoirs 100 and a set of tubes 102 that generally couple with one another inside a condenser housing 104. A coolant 106 may flow in and between the reservoirs 100 and the tubes 102 to generally cool and condense water vapor 108 in the atmospheric air surrounding the precipitation condenser 44. Cooling the water vapor 108 causes water in the atmosphere to condense out from being a gas. The liquid water condensate 110 may then exit the precipitation condenser 44 though the conduit 52 and be pumped into the water chamber 24 by the water pump 54, as described above.

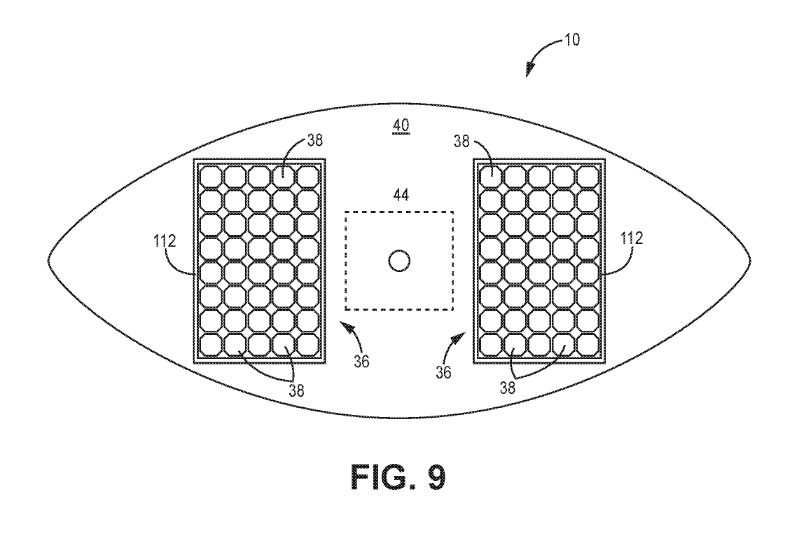

Lastly, FIG. 9 more specifically illustrates a top view of the air vehicle 10 including the solar power system 36. As shown, the solar power system 36 includes a plurality of the solar cells 38 housed within multiple solar panels 112 that may attached, as shown generally in FIGS. 2-5, to the top, upward-facing surface 40 of the air vehicle 10.

While the above illustrate one kind of air vehicle 10 in the form of a drone-type air vehicle, persons of ordinary skill in the art will appreciate and understand that the air vehicle 10 may apply to autonomous drones that rarely need to land, including as weather stations, cell phone data relay access points, internet relay access points, surveillance systems, as well as cargo or human transportation.

Although several embodiments have been described in detail for purposes of illustration, various modifications may be made without departing from the scope and spirit of the invention. Accordingly, the invention is not to be limited, except as by the appended claims.

What is claimed is:

1. An air vehicle, comprising:
a housing having a first chamber for retaining a buoyant fluid having a density relatively lower than atmospheric air and a second chamber for retaining a fuel;
a generator coupled with the housing for supplying renewable electricity to the air vehicle;
an electrolyzer operating off electricity supplied by the generator and fluidly coupled with the fuel in the second chamber for producing quantities of the buoyant fluid while the air vehicle is airborne for storage in the first chamber, the first chamber being of a size and shape to retain a sufficient quantity of the buoyant fluid such that the air vehicle may continuously have an overall density relatively lower than atmospheric air to remain airborne therein; and
a fuel producer operating off electricity supplied by the generator for producing the fuel from a renewable resource while the air vehicle is airborne.

2. The air vehicle of claim 1, wherein the fuel comprises a non-carbon based fuel and the air vehicle remains airborne in atmospheric air with zero carbon emissions.

3. The air vehicle of claim 1, wherein the fuel producer comprises a precipitation condenser, the fuel comprises water, and the second chamber comprises a water storage tank.

4. The air vehicle of claim 1, wherein the buoyant fluid comprises hydrogen and the first chamber comprises a hydrogen tank.

5. The air vehicle of claim 1, including a third chamber comprising an oxygen storage tank for selectively receiving and retaining a quantity of oxygen.

6. The air vehicle of claim 5, wherein each of the first chamber, the second chamber, and the third chamber comprise deformable chambers that vary in volumetric size and shape depending on the relative quantity of the buoyant fluid, the fuel, and the oxygen within the housing.

7. The air vehicle of claim 5, including a fuel cell fluidly coupled with the buoyant fluid in the first chamber and the oxygen in the third chamber for generating electricity and water therefrom.

8. The air vehicle of claim 7, including a water recycling system fluidly coupling the fuel cell to the fuel producer or the second chamber.

9. The air vehicle of claim 5, wherein each of the first chamber, the second chamber, and the third chamber are generally oriented vertically relative to one another, with the first chamber being positioned at a bottom of the air vehicle, the third chamber being positioned above and adjacent the first chamber, and the second chamber being positioned above and adjacent the third chamber within the housing.

10. The air vehicle of claim 5, including a first pump for moving pressurized fuel from the second chamber to the electrolyzer and a second pump for moving pressurized oxygen from the electrolyzer to the oxygen storage chamber.

11. The air vehicle of claim 1, wherein the air vehicle includes a center of gravity below a mid-height of the air vehicle.

12. The air vehicle of claim 1, wherein the generator comprises a solar panel coupled to an exterior surface of the housing and comprising a relatively lightweight solar PV material having a thickness of less than 50 microns.

13. The air vehicle of claim 12, wherein the solar panel selectively moves relative to the housing for reorientation relative to a sun.

14. The air vehicle of claim 1, including a controller simultaneously operating the generator, the electrolyzer, and the fuel producer in real-time to self-regulate an airborne height of the air vehicle.

15. The air vehicle of claim 1, including a battery storage system electrically coupled with the generator for receiving and storing electricity.

16. The air vehicle of claim 1, wherein the housing comprises a rigid material.

17. The air vehicle of claim 1, including at least one vent for releasing at least one of the buoyant fluid from the first chamber or the fuel from the second chamber.

18. The air vehicle of claim 1, including a first check valve positioned between the second chamber and the electrolyzer to prevent backflow of fuel to the second chamber, and a second check valve positioned between the fuel producer and the second chamber to prevent backflow of the fuel to the fuel producer.

19. The air vehicle of claim 1, wherein the fuel is gravity fed from the fuel producer to the second chamber.

20. A process for operating an air vehicle airborne, comprising the steps of:
storing a quantity of a buoyant fluid having a density relatively lower than atmospheric air in a first chamber of a housing of the air vehicle;
retaining a quantity of a fuel in a second chamber of the housing of the air vehicle;
producing the buoyant fluid for storage in the first chamber from the fuel in the second chamber while the air vehicle is airborne, the first chamber being of a size and shape to retain a sufficient quantity of the buoyant fluid such that the air vehicle continuously has an overall density relatively lower than atmospheric air to remain airborne; and
resupplying the fuel to the second chamber from a renewable resource while the air vehicle remains airborne.

21. The process of claim 20, wherein the producing step includes the step of producing hydrogen and oxygen with an electrolyzer.

22. The process of claim 22, including the step of pumping the hydrogen from the electrolyzer to the first chamber as the buoyant fluid and storing the oxygen produced by the electrolyzer in an oxygen chamber.

23. The process of claim 22, including the steps of:
generating electricity and water with a fuel cell from the hydrogen in the first chamber and the oxygen in the oxygen chamber; and
pumping the water from the fuel cell to the second chamber.

24. The process of claim 20, wherein the resupplying step includes the step of precipitating water from atmosphere with a condenser.

25. The process of claim 24, including the step of pumping the precipitated water from the condenser to the second chamber.

26. The process of claim 20, including the step of controlling an altitude of the air vehicle by regulating the quantity of buoyant fluid within the first chamber or regulating the quantity of fuel in the second chamber.

27. The process of claim 26, including the step of expanding the first chamber and increasing the pressure therein by increasing the quantity of buoyant fluid therein, thereby reducing the overall density of the air vehicle.

28. The process of claim 26, including the step of expanding the second chamber and increasing the pressure therein by increasing the quantity of the fuel therein, thereby increasing the overall density of the air vehicle.

29. The process of claim 26, including the step of expelling at least one of the buoyant fluid or the fuel from the air vehicle to atmosphere while airborne.

30. The process of claim 20, including the step regulating operation of a solar panel, a condenser, an electrolyzer, or a fuel cell in real-time with a controller.

31. The process of claim 30, including the step of generating electricity from the solar panel.

32. The process of claim 30, including the step of increasing the quantity of the fuel in the second chamber by activating the condenser and decreasing the quantity of the fuel in the second chamber by activating the electrolyzer.

33. The process of claim 30, including the step of increasing the quantity of buoyant fluid in the first chamber by activating the electrolyzer and decreasing the quantity of buoyant fluid in the first chamber by activating the fuel cell.
